(19) United States
(12) Patent Application Publication
(10) Pub. No.: US 2026/0002804 A1
(43) Pub. Date: Jan. 1, 2026

(54) METHOD FOR OPERATING A MAGNETIC-INDUCTIVE FLOWMETER AND MAGNETIC-INDUCTIVE FLOWMETER

(71) Applicant: KROHNE AG, Basel (CH)

(72) Inventors: Guus REIJNDERS, Stampersgat (NL); Robin STEVENHAGEN, Maassluis (NL)

(73) Assignee: KROHNE AG, Basel (CH)

(21) Appl. No.: 19/253,407

(22) Filed: Jun. 27, 2025

(30) Foreign Application Priority Data
Jun. 28, 2024 (DE) 10 2024 118 332.2

(51) Int. Cl. G01F 1/60; G01F 1/58

(52) U.S. Cl. CPC G01F 1/60; G01F 1/584

(57) ABSTRACT

A method for operating a magnetic-inductive flowmeter is provided. The magnetic-inductive flowmeter comprises at least one measuring tube with an inflow region, an outflow region, and a measuring region located between the inflow and outflow regions for performing a flowing medium through the flowmeter; At least one magnetic field generating device generates a magnetic field passing through the measuring tube in the measuring region substantially perpendicular to the direction of flow of the medium. At least one pair of measuring electrodes in the measuring region of the measuring tube taps an electrical voltage induced in the medium in the measuring tube. At least one control and evaluation unit which, in a flow measurement mode, determines a flow measurement value from the measured induced electrical voltage. In a fill level measuring mode, a measuring current is fed into the medium in the measuring tube via circuit electrodes.

This nonprovisional application claims priority under 35 U.S.C. § 119(a) to German Patent Application No. 10 2024 118 332.2, which was filed in Germany on Jun. 28, 2024, and which is herein incorporated by reference.

### BACKGROUND OF THE INVENTION

### Field of the Invention

The invention relates to a method for operating a magnetic-inductive flowmeter, wherein the magnetic-inductive flowmeter comprises at least one measuring tube with an inflow region, an outflow region and with a measuring region located between the inflow region and the outflow region for conducting a flowing medium through the flowmeter, at least one magnetic field generating device for generating a magnetic field passing through the measuring tube in the measuring region perpendicular to the direction of flow of the medium, at least one pair of measuring electrodes in the measuring region of the measuring tube for tapping an electrical voltage induced in the medium in the measuring tube, and at least one control and evaluation unit which determines a flow measurement value from the measured induced electrical voltage in a flow measurement mode. In addition, the invention also relates to such a magnetic-inductive flowmeter.

### Description of the Background Art

Flowmeters, which are based on the magnetic-inductive measuring principle, are known. Consequently, methods for operating such flowmeters are also been known. The magnetic-inductive measuring principle is based on the action of force on charge carriers that move perpendicular to a magnetic field or that have a component of movement perpendicular to the magnetic field in question (Lorentz force). In order to be able to perform a flow measurement based on this principle in “normal operation” of the flowmeter, i.e. in flow measurement mode, the medium in the measuring tube must have a minimum electrical conductivity. The faster the medium moves through the measuring tube and thus also through the magnetic field generated by the magnetic field generating device, the stronger the separation of charge carriers in the flowing medium of the corresponding measuring tube section, and the stronger the electric field caused by the charge separation, which forms between the electrodes of the measuring tube and can be picked up as an induced electric voltage between the measuring electrodes. The induced voltage between the measuring electrodes develops in proportion to the flow velocity, at least during the period in which the magnetic field is constant.

The principle of magnetic-inductive flow measurement has proven to be a reliable measuring principle, but it is known that magnetic-inductive flowmeters react sensitively to the flow profile of the medium flowing through the measuring tube or to a change in the flow profile. A partially filled measuring tube is the most massive form of such a disturbance of the flow profile. Magnetic-inductive flowmeters are calibrated with the measuring tube completely filled and therefore with the medium flowing through the entire cross-section; accordingly, magnetic-inductive flowmeters only provide correct measured values if the requirement of a completely filled and completely flowing measuring tube is met. As a result, when operating a magnetic-inductive flowmeter, it is of interest to detect a measuring tube that is only partially filled (or completely empty), as the measured values are no longer reliable in this situation and there may also be a disturbance in the process. Various methods of detecting partially filled measuring tubes are known from the state of the art.

### SUMMARY OF THE INVENTION

It is therefore an object of the present invention to provide an improved method for determining the fill level of a medium using a magnetic-inductive flowmeter.

In an example, the object is initially achieved by arranging a first current circuit electrode and a second current circuit electrode in the area of the measuring tube in contact with the medium, at least when the measuring tube is completely filled with medium, by connecting the current circuit electrodes to a current source outside the measuring tube and by specifying a target measuring current in a fill level measuring mode of the current source, to which the current circuit electrodes are subjected. The current circuit electrodes are arranged in such a way that a level circuit closes in the medium via a medium current path, at least when the measuring tube is completely filled with medium, wherein the medium current path passes through the flow cross-section of the measuring tube in which the measuring electrodes are located, so that an electrical voltage drop occurs between the current circuit electrodes in the medium.

In fill level measuring mode, a dry circuit electrode and/or a dry measuring electrode is detected by measurement-based capture and evaluation of at least one of the following variables: at least one of the captured measuring electrode voltages, the measuring current emitted by the current source, an feed voltage at the first circuit electrode caused by the current source. A dry electrode means that the electrode has no or only very limited electrical contact with the medium volume in the measuring tube, i.e. in comparison to the state when the measuring tube is completely filled, for example, and the medium volume surrounds the electrode and is not only wetted in a thin layer due to residual adhesions when the fill level has dropped.

If a dry circuit electrode and/or a dry measuring electrode is detected, the “dry electrode” status is signaled at least indirectly. “Signaling” can mean that the status is technically recognizable, for example by setting a corresponding flag in the magnetic-inductive flowmeter, by displaying a corresponding message on a display of the magnetic-inductive flowmeter, or by transmitting a message via an external interface to outside the magnetic-inductive flowmeter (fieldbus interface, current interface with superimposed HART protocol, Ethernet, Bluetooth, etc.). Indirect signaling can mean that the message “dry electrode” does not have to be signaled explicitly; instead, messages can be signaled in a similar way, for example regarding the fill level, indicating a partial fill, etc.

The invention is based on the idea of integrating the medium in the measuring tube as part of the level circuit, so that a change in the medium level has an influence on the electrical properties of the level circuit itself (electrical resistance of the level circuit) and also on its immediate surroundings (change in the voltage drop in the medium along the medium current path). By observing the electrical behavior of the fill level circuit, it is easy to determine whether the circuit electrodes and/or measuring electrodes are dry and thus also the fill level of the medium in the measuring tube. The measuring electrode voltages, which are captured anyway for the flow measurement operation, are particularly easy to observe. This also applies to the measuring current emitted by the current source, which is usually captured by the current source as a control variable anyway, and also to the feed voltage at the first current circuit electrode caused by the current source, as this is the control variable of the current source to set the specified target measuring current.

In the method according to the invention, it has been found to be advantageous that the measuring electrodes, which are used in flow measurement mode to capture the electrical voltage induced in the medium, are not used in fill level measurement mode to feed an electrical measuring signal suitable for fill level measurement into the medium; the circuit electrodes, which are different from the measuring electrodes, are provided for this purpose. One reason for this is that a current flow via the measuring electrodes can result in undesirable electrical and electrochemical effects on the measuring electrodes, which can have a detrimental effect on the flow measurement. Another advantage of the solution according to the invention is the avoidance of a complex circuitry solution in order to reconcile a sensitive voltage measurement on one hand and the introduction of a robust measuring signal on the other hand via the measuring electrodes. The method according to the invention is basically not concerned with the primary measurement mode of the magnetic-inductive flowmeter, i.e. the flow measurement mode, but with the secondary measurement mode, i.e. the fill level measurement mode, even if this is not always emphasized.

The solution according to the invention, in which a measuring current is applied to the medium via circuit electrodes—which are different from the measuring electrodes—in fill level measuring mode, avoids the problem points mentioned and also enables the measuring electrodes, which are in principle associated with the possibility of highly sensitive voltage measurement, to be used to precisely capture a relevant measured variable for fill level measurement, namely a measuring electrode voltage caused by the impressed measuring current in the medium.

The measuring tube can extend over the entire length of the flowmeter, from the inflow region to the outflow region, including any terminals for mounting the flowmeter, insofar as these also carry the medium. The magnetic-inductive flowmeter is usually installed according to standard installation in such a way that the measuring electrodes lie on a horizontal connecting line and the magnetic field generating device generates a vertical magnetic field perpendicular to this, i.e. in the direction of the earth's gravitational field. In normal measuring mode, the medium completely fills and flows through the flowmeter. The determination of the flow measurement value is also based on this assumption.

The specific arrangement of the circuit electrodes and the measuring electrodes in the area of the measuring tube determines how low the fill level of the medium in the measuring tube can drop before a circuit electrode or a measuring electrode is dry and a dry circuit electrode or dry measuring electrode is detected or a fill level below the installation height of the highest circuit electrode or the highest measuring electrode is detected.

In the arrangement of the current circuit electrodes, attention should be paid that they are in contact with the medium only in a completely predetermined fill state, for example, a completely filled state of the measuring tube so that the measuring current fed into the medium via the current circuit electrodes can form a closed circuit via its medium current path. The circuit electrodes should be arranged in the area of the measuring tube in such a way that the measuring current path passes through the area of the measuring electrodes so that the measuring current has a measurement-based detectable influence on the measuring electrodes and thus a closed level circuit can be detected via the medium by means of the measuring electrode voltages captured via the measuring electrodes.

By capturing and evaluating one or more of the variables a) captured measuring electrode voltage(s), b) measuring current emitted by the current source, c) supply voltage at the first circuit electrode caused by the current source, it is possible to clearly determine which of the circuit electrodes and/or the measuring electrodes is dry. In this respect, an advantageous further development of the method is characterized in that when the status “dry electrode” is detected, it is additionally signaled which of the circuit electrodes and/or the measuring electrodes is dry, in particular wherein a level indication of the medium in the measuring tube is additionally given. Since no continuous fill level measurement is performed, but only selectively dry electrodes can be detected, a fill level indication is always to be understood as the maximum fill level, or as a fill level between the highest non-dry electrode and the lowest dry electrode.

Preferably, the first current circuit electrode is placed at a feed potential by the current source and the second current circuit electrode is placed at a reference potential by the current source, in particular wherein the reference potential is the electrical reference potential to which the measuring electrode voltages are also measured. Advantageously, the reference potential is the electrical ground of the measuring circuit of the flowmeter.

In a design of the method, the current source generates an alternating current with a constant amplitude as the measuring current. When the measuring electrode voltages are evaluated during fill level measurement mode, the quantity of interest of the measuring electrode voltage is, in particular, then the amplitude of the measuring electrode voltage. The use of an alternating current has the advantage that electrochemical effects on the electrodes, in this case the current circuit electrodes, which may be associated with a direct current or a direct voltage, are avoided. The electronic measuring system, which evaluates the measuring electrode voltage, is also set up to capture alternating voltages anyway, as the polarity of the electrical voltage induced in the medium also changes its sign due to the magnetic field of the magnetic field generating device, which usually changes its polarity. An alternative variation of the method is that the current source generates a direct current with a constant level, which is easy to implement.

The measuring current emitted by the current source can be captured measurement-based in fill level measuring mode to test a dry circuit electrode and at least one dry circuit electrode is identified if the measured measuring current falls below the target measuring current specified for the current source. If a circuit electrode is dry, the level circuit is interrupted and no measuring current can flow. Situations are conceivable in which the level circuit still conducts a certain measuring current with a dry circuit electrode, for example with a foaming medium or with a circuit electrode still wetted by a medium residue. In these cases, although the circuit electrode is no longer completely surrounded by the medium, it is only a foamed or wetted circuit electrode through which a certain current is conducted into the medium, albeit not the intended target measuring current. In particular, a dry circuit electrode is identified if the deviation is greater than a permissible maximum deviation, more preferably if the measured measurement current is less than a specified minimum measurement current, especially if the measured measurement current is zero (ideal case of dry circuit). A simple technical implementation of the measurement of the measuring current emitted by the current source is the use of a current measuring resistor that is connected in series in the fill level circuit. The current is then measured by measuring the voltage drop across the current measuring resistor.

A test for a dry circuit electrode in fill level measuring mode can be performed by determining the voltage difference between the measurement-based feed voltage at the first circuit electrode and a current source output voltage set by the current source, and a dry circuit electrode is identified if the absolute value of the determined voltage difference is less than a predetermined maximum voltage difference. The test is based on the consideration that a properly set measuring current from the current source will lead to a voltage drop via the resistance that is always present between the current source and the first current circuit electrode, which can be formed, for example, by a separately provided current measuring resistor, an internal current measuring resistor in the current source and the line resistance. This voltage drop is detected and evaluated as an indication of a closed level circuit in which no circuit electrode is dry. In the case of a dry circuit electrode, the measuring current is practically non-existent and is usually zero, so that no voltage drop can be detected in this case.

A further example provides, in a fill level measuring mode for testing a dry measuring electrode, that the voltage ratio of the captured measuring electrode voltage of the respective measuring electrode to the measurement-based supply voltage at the first circuit electrode is determined and a dry measuring electrode is identified when the determined voltage ratio of the respective measuring electrode falls below a predetermined voltage ratio value. This test is based on the knowledge that with an intact level circuit via the medium current path, the resulting electrical voltage drop in the medium leads to a non-zero measuring electrode voltage at a non-dry measuring electrode. The test assumes that the level circuit is intact, i.e. closed via the medium. Therefore, in a preferred design of this method, it is provided that a dry measuring electrode is only inferred when a test for a dry circuit electrode has also failed (if only one such test has been performed). If several tests have been performed on a dry circuit electrode, all of these tests should be negative.

A target measurement current with a characteristic time characteristic can be predetermined for the current source, in particular in the form of a rectangular sequence or a sawtooth curve, wherein, upon evaluation of one of the measurement-based variables, i.e. one of the captured measurement electrode voltages and/or the measurement current emitted by the current source and/or the supply voltage at the first circuit electrode caused by the current source, it is checked whether the measurement-based variable has a corresponding characteristic time characteristic. If the measurement-based quantity has a corresponding characteristic time characteristic, the measurement-based quantity is classified as reliably present, otherwise it is classified as not reliably present. This applies in particular if the measurement-based variable has a non-zero signal level but does not have the expected characteristic time characteristic. In particular, an unreliable capture of the relevant variable is signaled in this case.

The flow measurement mode can be suspended during the fill level measurement mode, in particular the magnetic field generating device is not energized, so that no magnetic field is generated during the fill level measurement and therefore no voltage is induced in the flowing medium. This reliably prevents mutual interference between the different operating modes.

Also, the fill level measurement mode can be performed at the same time as the flow measurement mode, i.e. also while the magnetic field generating device is energized. Usually, the magnetic field generating device is energized at a determined frequency in different directions, resulting in a magnetic field whose polarity changes with the switching frequency of the magnetic field generating device. The magnetic field strength cannot change abruptly, as the current through the magnetic field generating device, which naturally has a certain inductance, can only change continuously. When switching the direction of current flow, the magnetic field decreases in one direction, becomes zero and builds up again in the other direction until it becomes stationary after this transient phase. While the magnetic field is stationary, the measuring electrodes capture a number of values for the electrical voltage induced in the medium, from which the flow measurement value of interest is calculated (flow measurement mode). It has proven to be advantageous if the fill level measurement is performed either directly at the beginning of the changeover of the current flow direction, i.e. at the beginning of the transient phase of the magnetic field changeover, in which no measured values for the flow are captured anyway, or at the very end of the stationary phase of the magnetic field (and thus shortly before the changeover of the current flow direction), so that only a few measured values are affected that are relevant for the flow determination.

Information about at least the highest electrode of the measuring electrodes and current circuit electrodes can be stored in the magnetic-inductive flowmeter and preferably this electrode can be checked by a corresponding test for a dry measuring electrode or a corresponding test for a dry current circuit electrode, depending on whether it is a current circuit electrode or a measuring electrode. Highest means highest in the usual understanding, i.e. measured against the direction of the earth's gravitational field.

Also, information about at least the highest electrode of the measuring electrodes and circuit electrodes can be stored in the magnetic-inductive flowmeter and the result of a test carried out for a dry measuring electrode and/or a dry circuit electrode is subjected to a plausibility test using the information about the highest electrode. The plausibility test takes into account that the highest electrode is the first electrode to be dry or that the highest electrode must in any case be among the number of dry electrodes detected. In particular, it is therefore checked whether the highest electrode has been identified as the first electrode to be dry, or in particular whether the highest electrode has also been identified as dry in the case of several electrodes identified as dry. If the plausibility test is not passed, a corresponding error message is signaled.

Information about the installation height of several of the measuring electrodes and circuit electrodes can be stored in the magnetic-inductive flowmeter and, if several dry electrodes are detected, it can be checked whether these are the several highest electrodes.

The magnetic-inductive flowmeter can determine the highest electrode or several highest electrodes independently on the basis of the installation positions of the measuring electrodes and the current circuit electrodes in the magnetic-inductive flowmeter in a standard installation and on the basis of information about an actual installation deviating from the standard installation in which the magnetic-inductive flowmeter is actually installed.

The standard installation refers to the usual installation position of the magnetic-inductive flowmeter in the process, i.e. in a process pipe system, as recommended by the manufacturer. A recommended standard alignment is frequently encountered, wherein the two measuring electrodes lie on a horizontal connecting line, the longitudinal axis of the measuring tube is also aligned horizontally, the magnetic field generating device is aligned vertically and generates a magnetic field in the direction of the earth's gravitational field, wherein the measuring device electronics with transmitter and display typically mounted on the measuring tube (or on a housing surrounding the measuring tube) point vertically upwards. The measuring electrodes and the current circuit electrodes are permanently installed in the measuring tube at known positions. With standard alignment, it is therefore also known which electrode is in the highest position in relation to the direction of the earth's gravitational field, and of course it is also known which of the electrodes is in the highest position, which electrode is in the second highest position, etc. position.

In practice, the actual installation sometimes deviates from the standard installation, which can have various reasons, for example spatial conditions that do not allow a standard installation, or intentionally deviating installations, for example to enable certain reading positions in relation to a device display. For example, actual installations that deviate from the standard installation often involve overhead installation or swivel installations by +−90° around the longitudinal axis of the measuring tube.

In a design of the method, the information about the actual installation deviating from the standard installation, in which the magnetic-inductive flowmeter is actually installed, comprises at least one swivel angle with respect to an axis of rotation, in particular wherein the axis of rotation is the longitudinal axis of the measuring tube (orientation in the direction of flow of the medium). In a preferred design, swivel angles are captured with respect to three linearly independent—in particular Cartesian—axes of rotation.

The magnetic-inductive flowmeter can have an acceleration sensor that determines the one or more swivel angles. The new absolute positions of the measuring electrodes and the current circuit electrodes can then be calculated from the installation positions of the measuring electrodes and the current circuit electrodes in the magnetic-inductive flowmeter during standard installation by transforming the installation positions with a rotation matrix or several rotation matrices. By sorting the absolute positions according to their height, it is easy to determine which electrodes are dry as the first electrode, second electrode, etc. when the fill level of the medium in the measuring tube drops.

The methods described may all be implemented in magnetic-inductive flowmeters. In order to be able to perform the method according to the invention, a first current circuit electrode and a second current circuit electrode are arranged in the area of the measuring tube in contact with the medium in the corresponding flowmeters according to the invention, at least when the measuring tube is completely filled to a predetermined level or completely filled with medium, wherein the current circuit electrodes are connected to a current source outside the measuring tube and a setpoint measuring current is specified in a fill level measuring mode of the current source, with which the current circuit electrodes are acted upon. The current circuit electrodes are arranged in such a way that a level current circuit closes via a medium current path in the medium, at least when the measuring tube is completely filled with medium, wherein the medium current path passes through the flow cross-section of the measuring tube in which the measuring electrodes are located, so that an electrical voltage drop occurs between the current circuit electrodes in the medium.

In all magnetic-inductive flowmeters, the control and evaluation unit can be designed in such a way that it performs the method for implementing the fill level measurement mode in the fill level measurement mode.

Magnetic-inductive flowmeters according to the invention can be designed in different ways. In an advantageous design, it is provided that at least one of the circuit electrodes can be designed as a conductive flange at the end of the measuring tube (with medium contact).

A further development of the magnetic-inductive flowmeter is characterized in that one of the circuit electrodes can be designed both as a conductive flange in the inflow region and as a conductive flange in the outflow region of the measuring tube.

In example designs in which a circuit electrode is designed as a flange or as a connection piece of the magnetic-inductive flowmeter, it is advisable to place this circuit electrode on the reference potential, ideally on the electrical ground of the flowmeter.

In an example design of the magnetic-inductive flowmeter, one of the circuit electrodes can be arranged at an upper apex of a measuring tube cross-section transverse to the measuring tube axis, in particular at the highest apex of the measuring tube cross-section, wherein it is preferably assumed that the upper apex is present during standard installation of the magnetic-inductive flowmeter. This enables very early detection when the measuring tube develops from a completely filled state to a partially filled state.

In an example design of the magnetic-inductive flowmeter, one of the circuit electrodes in the area of the measuring tube can be arranged axially offset to a measuring electrode plane in which the measuring electrodes are arranged and which runs perpendicular to the axial extension of the measuring tube. Preferably, this current circuit electrode can be arranged between the inflow region and the outflow region; it could, for example, be embedded in the wall of the measuring tube, where it must be electrically insulated accordingly. In a further design, both circuit electrodes in the area of the measuring tube are arranged axially offset to the measuring electrode plane and between the inflow region and the outflow region.

In an example of the magnetic-inductive flowmeter, one of the current circuit electrodes can be arranged in the measuring electrode plane; both current circuit electrodes can also be arranged in the measuring electrode plane. This variation has manufacturing advantages, as only a limited area of the measuring tube has to be processed to implement the measuring electrodes and the current circuit electrodes (especially if these lie on a circumferential line of the measuring tube), but it has been found that better results can be achieved with regard to determining the fill level of the medium if the current circuit electrodes are arranged axially, i.e. offset from the measuring electrodes in the direction of flow of the medium, which therefore corresponds to the examples described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically a method for operating a magnetic-inductive flowmeter and a corresponding magnetic-inductive flowmeter in flow measurement mode, as known from the prior art,

FIGS. 2A and 2B show schematically a method for operating a magnetic-inductive flowmeter and a corresponding magnetic-inductive flowmeter in a novel fill level measurement mode,

FIGS. 3A and 3B show schematically characteristic time characteristics of the preset target measuring current of the current source and the measured measuring current,

FIGS. 4A and 4B show schematically characteristic time characteristics of the measured inflow voltage and the outflow voltage set by the current source,

FIGS. 5A to 5C show schematically magnetic-inductive flowmeter in standard installation and actual installation deviating from the standard installation, and

FIGS. 6A to 6D show schematically different implementations of current circuit electrodes in a magnetic-inductive flowmeter.

### DETAILED DESCRIPTION

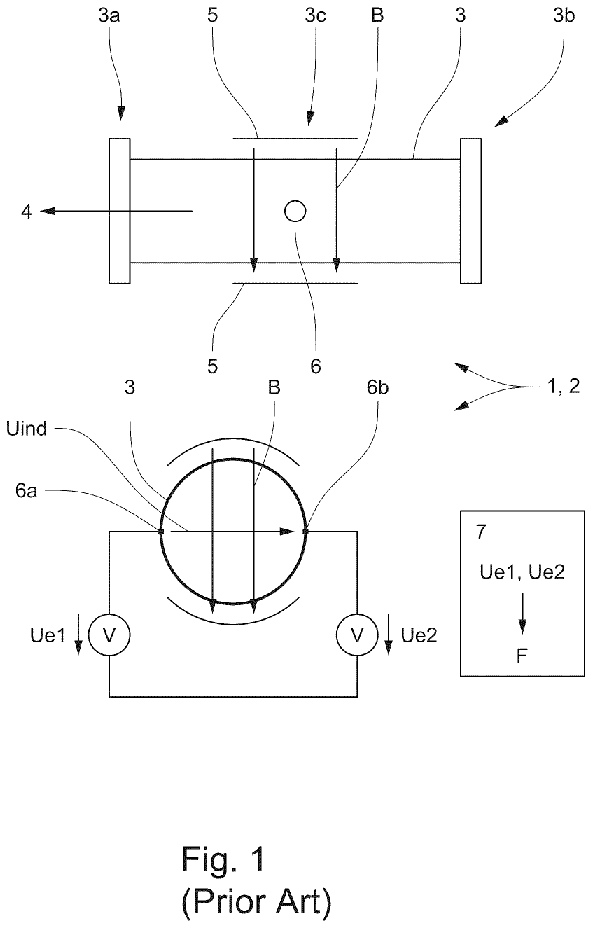

FIG. 1 shows a method 1 for operating a magnetic-inductive flowmeter 2 and a magnetic-inductive flowmeter 2 that performs this method 1, as known from the prior art. The flow measurement mode which is considered “normal operation” of a magnetic-inductive flowmeter 2 is shown, which involves capturing the flow of the medium through the flowmeter 2.

The magnetic-inductive flowmeter 2 has a measuring tube 3 with an inflow region 3a, an outflow region 3b and a measuring region 3c located between the inflow region 3a and the outflow region 3b for performing a flowing medium 4 through the flowmeter 2. The measuring tube 3 is therefore understood to be the entire area of the flowmeter 2 used to guide the medium flow, including any connecting parts, such as the flanges indicated here in the inflow region 3a and in the outflow region 3b.

In flow measurement mode, a magnetic field generating device 5 generates a magnetic field B that passes through the measuring tube 3 in the measuring region 3c perpendicular to the direction of flow of the medium 4. An electrical voltage Uind is induced in the medium 4, which must have a minimum electrical conductivity for the measuring principle to work, due to the Lorentz force exerted on moving charge carriers in the magnetic field B and the resulting charge separation. The induced electrical voltage Uind is proportional to the average flow velocity of the medium 4 in the flow cross-section in the measuring region 3c of the measuring tube 3, provided that the magnetic field strength B remains constant.

A pair of measuring electrodes 6a, 6b is arranged in the measuring region 3c of the measuring tube 3 for tapping the electrical voltage Uind induced in the medium 4 in the measuring tube 3. The connecting line between the two measuring electrodes 6a, 6b runs perpendicular to the direction of flow of the medium as well as perpendicular to the field lines of the magnetic field B in order to achieve a maximum measuring effect. The measuring electrodes 6a, 6b are electrically insulated from the wall of the measuring tube 3 and embedded in the wall of the measuring tube 3. In flow measurement mode, a control and evaluation unit 7 determines a flow measurement value F from the measured induced electrical voltage Uind. The illustration in FIG. 1 (as well as in the following figures) is actually very schematic. For example, it is not shown in detail how the measured values of the electrode voltages Ue1, Ue2 reach the control and evaluation unit 7. It is also not explicitly shown that the electrical voltage Uind induced in the medium 4 results from the difference between the two measuring electrode voltages Ue1, Ue2, but this is not important in detail or is known to the skilled person anyway.

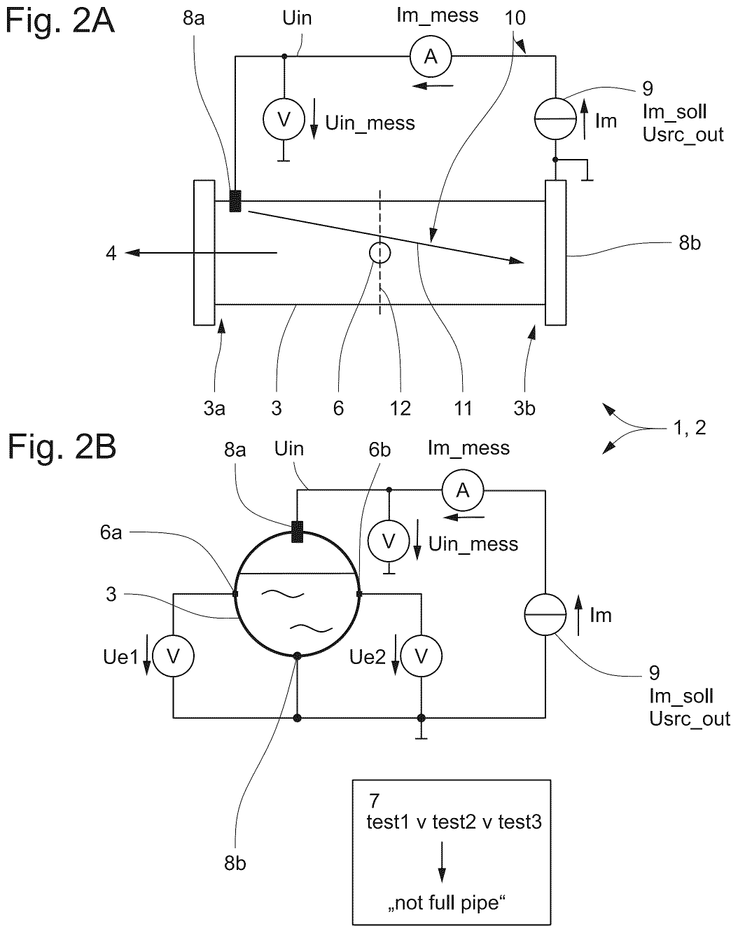

In the following FIGS. 2 to 6, various aspects of a method 1 for operating a magnetic-inductive flowmeter 2 and a corresponding magnetic-inductive flowmeter 2 are shown. However, the focus is not on flow measurement, but on determining the fill level of the medium 4 flowing through the magnetic-inductive flowmeter 2, namely via the identification of dry measuring electrodes 6 and/or current circuit electrodes 8 so essentially the focus is on a fill level measurement mode that is different from the flow measurement mode.

The examples in FIGS. 2 to 6 have in common that, for the sake of clarity, the magnetic field generating device is not shown. Another common feature of the examples is that a first circuit electrode 8a and a second circuit electrode 8b are arranged in the area of the measuring tube 3 At least when the measuring tube 3 is completely filled with medium, the current circuit electrodes 8 are in contact with the medium 4. In fill level measuring mode, a target measuring current Im_soll is specified for the current source 9, which is applied to the circuit electrodes 8a, 8b. The circuit electrodes 8a, 8b are arranged in such a way that a level circuit 10 closes via a medium flow path 11 in the medium 4 at least when the measuring tube 3 is completely filled with a medium or when the measuring tube 3 is completely filled with the medium to a predetermined level. The medium current path 11 passes the flow cross-section of the measuring tube 3 in which the measuring electrodes 6a, 6b are located, resulting in an electrical voltage drop between the circuit electrodes 8a, 8b in the medium 4 and thus also an electrical potential in the medium 4 that can be captured by the measuring electrodes 6a, 6b.

If the fill level of the medium 4 in the measuring tube 3 changes, electrodes, i.e. circuit electrodes 8a, 8b and/or measuring electrodes 6a, 6b, will—depending on the fill level—no longer be in contact with the medium 4 or only to a very limited extent (via a thin medium film, a residual adhesion of the medium or foamed medium, etc.), at least in comparison to the situation when the medium 4 completely covers the electrodes 6, 8 as a fluid. The electrodes 6, 8, which are no longer covered with the medium 4 in the sense described and are in contact with it, are then dry.

In fill level measuring mode, a dry circuit electrode 8a, 8b and/or a dry measuring electrode 6a, 6b is detected by measurement-based capture and evaluation of at least one of the following variables: at least one of the captured measuring electrode voltages Ue1, Ue2, the measuring current Im emitted by the current source 9, a supply voltage Uin caused by the current source 9 at the first circuit electrode 8a.

If a dry circuit electrode 8a, 8b and/or a dry measuring electrode 6a, 6b is detected, the “dry electrode” status is signaled, i.e. made technically identifiable. In the examples, the “dry electrode” status is signaled by setting a corresponding flag in the control and evaluation unit 7 and by displaying the message “not full pipe” on a display 16 of the magnetic-inductive flowmeter 2 shown in each case.

In the method 1 and the corresponding magnetic-inductive flowmeter 2, the medium 4 in the measuring tube 3 is integrated as part of the level circuit 10, so that a change in the medium level has an influence on the electrical properties and the electrical behavior of the level circuit 10 itself (electrical resistance of the level circuit) and also on its immediate surroundings (change in the voltage drop in the medium 4 along the medium current path 11). By observing the electrical behavior of the level circuit 10, it is easy to determine whether circuit electrodes 8a, 8b and/or measuring electrodes 6a, 6b are dry. This also allows conclusions to be drawn about the fill level of the medium 4 in the measuring tube 3, at least based on the positions of the electrodes 6, 8 detected as dry.

The magnetic-inductive flowmeter 2 shown in FIG. 2 and the method 1 carried out with this magnetic-inductive flowmeter 2 works with all the aforementioned different electrical variables of the level circuit 10, which are captured and evaluated measurement-based. The measuring electrode voltages Ue1, Ue2 are easily observable as they are captured for the flow measurement operation anyway. The measuring current Im, emitted by the current source 9, can be captured by the current source 9 as a controlled variable and is thus available, but it can also be easily determined by separate measurement, as can be seen from FIG. 2 (Im_mess). The supply voltage Uin at the first circuit electrode 8a caused by the current source 9 can be captured measurement-based without great effort and thus made available to the method 1. In other implementations of the method 1 and the associated magnetic-inductive flowmeter 2, only one of the three variables can also be captured and evaluated, or a combination of two of the three variables mentioned, measuring electrode voltage(s) Ue1, Ue2, measuring current Im emitted by the current source 9, feed voltage Uin caused by the current source 9 at the first current circuit electrode 8a, can be captured and evaluated. By combining several of the captured and evaluated variables, more accurate or more reliable statements can be made as to which electrode 6, 8 is actually dry or which electrodes are actually dry.

FIG. 2A shows a schematic side view of the magnetic-inductive flowmeter 2, in which the measuring tube 3 is completely filled. FIG. 2B shows the magnetic-inductive flowmeter 2 viewed in the axial direction of the measuring tube 3, wherein the measuring tube 3 is only partially filled; the level of the medium 4 is above the measuring electrodes 6a, 6b but below the first circuit electrode 8a, which is therefore dry.

Since the measuring tube 3 in FIG. 2A is completely filled with the medium 4, which has a minimum conductivity, a medium flow path 11 can form in the medium 4. The medium current path 11 runs from the first circuit electrode 8a, which is electrically insulated and embedded in the measuring tube 3, to the second circuit electrode 8b designed as a flange (from top left to right), wherein the flange is also electrically insulated from the adjacent area of the measuring tube 3. The positions of the circuit electrodes 8a, 8b are selected so that the medium flow path 11 passes the flow cross-section 12 of the measuring tube 3 in which the measuring electrodes 6a, 6b are located, so that an electrical voltage drop occurs between the circuit electrodes 8a, 8b in the medium 4 and this electrical voltage can be detected in the medium 4 by the measuring electrodes 6a, 6b. The current circuit electrodes 8a, 8b are arranged in such a way that the medium current path 11 has an axial extension in its course, i.e. in the direction of flow of the medium 4 or in the direction of the longitudinal axis of the measuring tube 3, which has proven to be particularly advantageous for the detectability of the electrical voltage in the medium 4 by the measuring electrodes 6a, 6b.

In the examples, the first current circuit electrode 8a is connected from the current source 9 to a feed potential Uin and the second current circuit electrode 8b is connected to a reference potential, wherein the reference potential is the electrical reference potential to which the measuring electrode voltages Ue1, Ue2 are also measured. In the examples, the reference potential is also the electrical mass of the magnetic-inductive flowmeter 2.

In an example that can be easily explained using FIG. 2a, both flanges, i.e. the inlet and outlet flanges of the measuring tube 3, are designed as a second circuit electrode 8b and are therefore connected to the electrical device ground. The medium flow path 11 is then divided into two parts, it runs on the one hand as shown in FIG. 2A, but on the other hand also from the first circuit electrode 8a to the left-side flange.

The method 1 implemented in the magnetic-inductive flowmeter 2 shown in FIG. 2 is characterized in that the measuring current Im emitted by the current source 9 is measured in the fill level measuring mode for the test test1 of a dry circuit electrode 8a, 8b. In the present case, the measurement of the measuring current Im emitted by the current source 9 consists of the use of a current measuring resistor, which is connected in series in the level circuit 10 and is symbolized as an ammeter A in FIG. 2. The measurement of the measured current Im_mess is then carried out by measuring the voltage drop across the current measuring resistor. If the measured measuring current Im_mess falls below the target measuring current Im_soll specified for the current source 9, at least one dry circuit electrode 8a, 8b is identified. In this case, it is checked whether the measured measuring current Im_mess is close to zero. If the fill level circuit 10 is interrupted due to a falling medium fill level, the real current source 9 can no longer drive the predetermined target measuring current Im_soll through the fill level circuit 10, which is a reliable indicator of a dry circuit electrode 8.

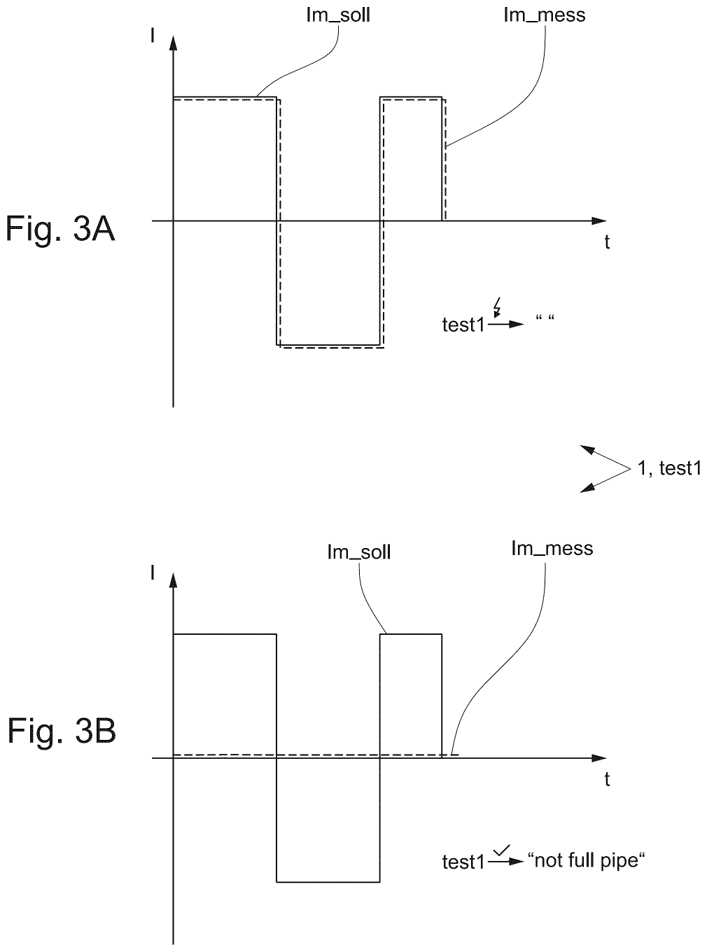

FIGS. 3A, 3B show the curves of the variables that form the basis for the described test test1 for a dry circuit electrode 8a, 8b. FIG. 3A shows the case of non-dry circuit electrodes 8a, 8b, in which the level circuit 10 is intact, i.e. corresponding to the situation shown in FIG. 2A, so that the current source 9 can feed a measuring current Im into the level circuit 10 and the measured measuring current Im_mess corresponds to the target measuring current Im_soll in its course and level. The test test1 for a dry circuit electrode 8a, 8b therefore fails, so that the status “dry electrode” is not signaled (“ ”). FIG. 3B shows the corresponding result in the case of the dry circuit electrode 8a according to FIG. 2B, in which the captured measuring current Im_mess is practically zero due to the interrupted level circuit 10 and the test test1 signals a dry electrode by outputting the message “not full pipe”.

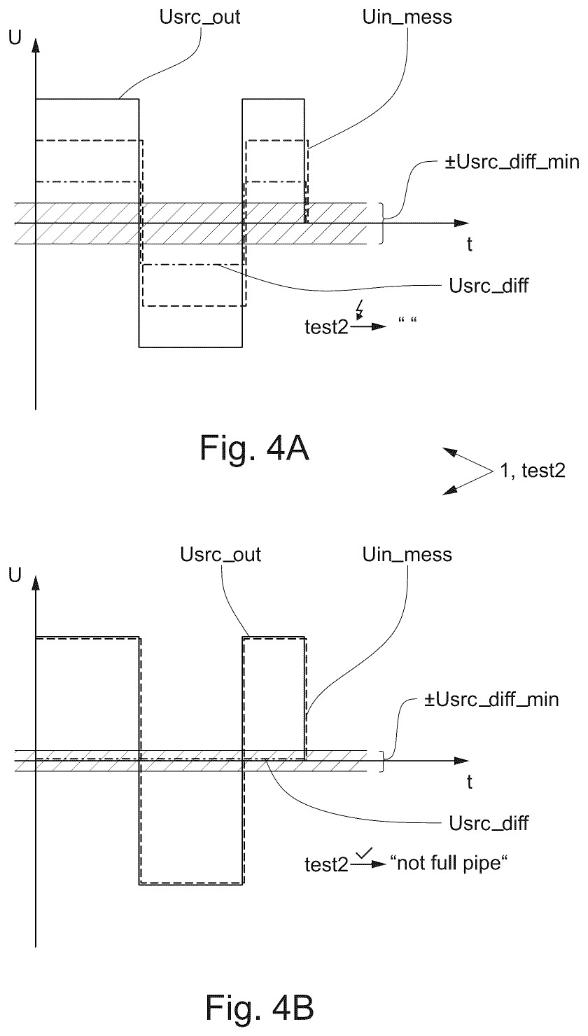

In the method 1 in the magnetic-inductive flowmeter 2 according to FIG. 2, a further test test2 is provided for a dry circuit electrode 8a, 8b in fill level measuring mode, which is explained using the corresponding curve progressions in FIGS. 4A (no dry electrode) and 4B (dry electrode). In this test test2, the voltage difference Usrc_diff between the measured input voltage Uin_mess at the first circuit electrode 8a and a current source output voltage Usrc_out set by the current source 9 is determined. A dry circuit electrode 8a, 8b is identified if the absolute value of the determined voltage difference is less than a predetermined minimum voltage difference Usrc_diff_min, i.e. the condition Usrc_diff=(Usrc_out−Uin_mess)<Usrc_diff_min is checked. It is also possible to test for the voltage difference zero, wherein a finite measurement accuracy should also be taken into account here. This test makes use of the circumstance that the measuring current Im set by the current source 9 generates a voltage drop on the path from the current source 9 to the first circuit electrode 8, which is also an indicator of the flowing measuring current Im, without the measuring current Im having to be measured directly. FIG. 4A illustrates this test test2 with a non-dry circuit electrode 8a. In the case of the dry circuit electrode 8a as shown in FIG. 4B, no measuring current Im flows, so that the two voltages Usrc_out and Uin_mess are equal and the voltage difference Usrc_diff is zero and therefore less than Usrc_diff_min due to the lack of voltage drop. The test test2 for a dry circuit electrode is positive and the status of a dry circuit electrode 8a, 8b is signaled by outputting the message “not full pipe”.

The method 1 and the magnetic-inductive flowmeter 2 according to FIG. 2 further comprise a test test3 on a dry measuring electrode 6a, 6b. For this purpose, a voltage ratio Ue1/Uin_mess, Ue2/Uin_mess of the captured measuring electrode voltage Ue1, Ue2 of the respective measuring electrode 6a, 6b to the measurement-based supply voltage Uin_mess at the first circuit electrode 8a is determined. A dry measuring electrode 6a, 6b is identified if the determined voltage ratio of the respective measuring electrode 6a, 6b falls below a predetermined voltage ratio value Urel. It is therefore checked whether the condition Ue1/Uin_mess<Urel, or correspondingly whether Ue2/Uin_mess<Urel. In an alternative design of test3, the test simply checks whether the captured measuring electrode voltage Ue1, Ue2 falls below a predetermined low value or is zero. However, this procedure does not take into account the fact that the measuring electrode voltage Ue1, Ue2 is dependent on the conductivity of the medium 4 when a measuring current of a constant level is impressed into the level circuit 10. This is taken into account in the first version of test test3 shown. The measurement curves of the variables involved are not shown separately, but the curves look similar to the curves shown in FIGS. 3 and 4.

In order to increase the reliability of the test test3, a dry measuring electrode 6a, 6b is only concluded when the test test1, test2 on a dry circuit electrode 8a, 8b has also failed, because no measuring electrode voltage Ue1, Ue2 can be captured if no measuring current Im is fed into the level circuit 10.

In the methods 1 shown in FIGS. 2 to 6, a target measuring current Im_soll with a characteristic time characteristic is specified for the current source 9 in fill level measuring mode, which in itself has a higher detection value due to its characteristic, in particular a higher detection value than a DC value or a harmonic oscillation. FIGS. 3 and 4 show, for example, a square wave sequence with pulse lengths in the ratio 4/3/2. When evaluating one of the measurement-based quantities, i.e. one of the captured measuring electrode voltages Ue1, Ue2, the measuring current Im emitted by the current source 9 or the supply voltage Uin at the first current circuit electrode 8a caused by the current source 9, it is checked whether the measurement-based quantity has a corresponding characteristic time characteristic. If the measured quantity has a corresponding characteristic time characteristic, the measured quantity is classified as reliable, otherwise it is classified as not reliable. This applies in particular if the captured variable has a non-zero signal level but does not show the expected characteristic time characteristic. This is obvious when you consider that the signal level “zero” is in some cases characteristic of a dry electrode and naturally cannot show such a characteristic time curve.

In the example shown, the flow measurement mode is suspended during the fill level measuring mode, in particular the magnetic field generating device 5 is not energized, so that no magnetic field B is generated and thus no disturbing induction voltage can occur in the medium 4.

In the example of the method 1 and the magnetic-inductive flowmeter 2 shown here, it is also implemented that when the “dry electrode” status is detected, it is additionally signaled which of the circuit electrodes 8a, 8b and/or the measuring electrodes 6a, 6b is dry.

Some designs of the method 1 and the corresponding magnetic-inductive flowmeter 2 make use of additional information, namely about which of the electrodes 6a, 6b, 8a, 8b is the highest electrode, or also information about the order in which the electrodes 6a, 6b, 8a, 8b are the highest. “Highest” means a height indication measured in the opposite direction to the direction of the earth's gravitational field. According to this understanding, a decreasing fill level of the medium 4 in the measuring tube 3 means that the highest electrode is dry first, then the second highest electrode is dry and so on. This information about the height of an electrode must always be understood in relation to the specific installation state of the magnetic-inductive flowmeter 2. The information about the height of the electrodes 6, 8 can then be used to make an ambiguous level test test1, test2, test3 unambiguous, but the information can also be used to subject the result of a level test test1, test2, test3 to an additional plausibility test.

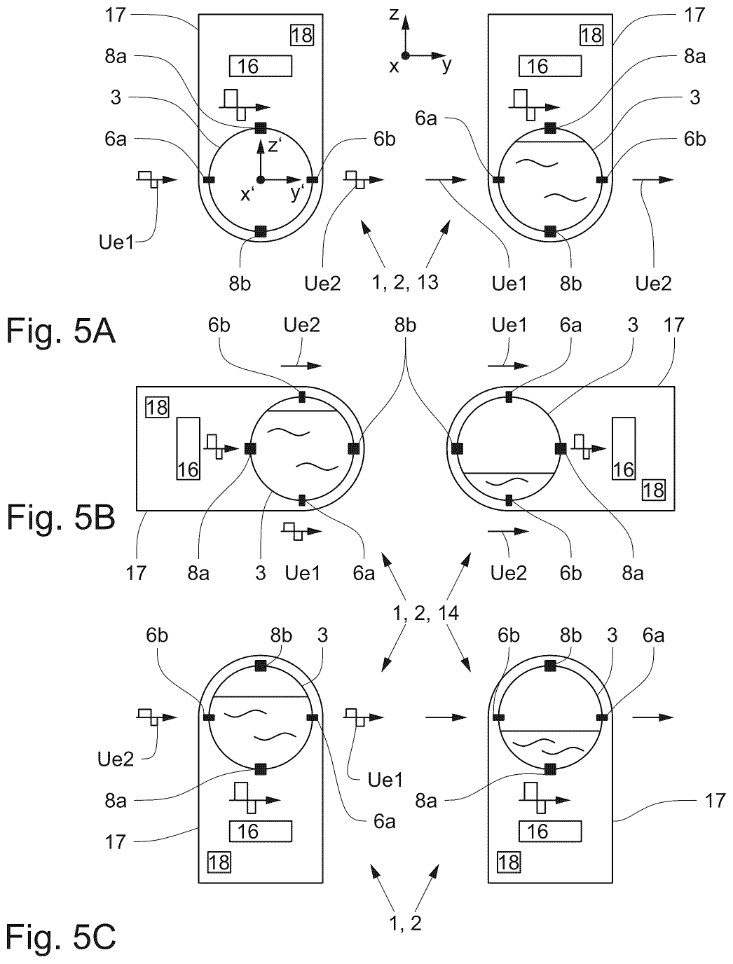

FIG. 5 shows several magnetic-inductive flowmeters 2 with a housing 17 surrounding the measuring tube 3 and a display 16 provided in the housing, on which, for example, flow measurement values are displayed. The magnetic-inductive flowmeters 2 are shown in various installation situations, wherein the device coordinate system x, y, z shown in FIG. 5a for standard installation 13 indicates the orientation of the magnetic-inductive flowmeter in standard installation 13: The x-axis points perpendicular to the earth's gravitational field and in the axial direction of the measuring tube 3, the y-axis lies in a measuring tube cross-section, perpendicular to the earth's gravitational field and points in the direction of the connecting line of the measuring electrodes 6a, 6b, the z-axis points in the opposite direction to the direction of the earth's gravitational field. The standard installation 13 refers to the usual and manufacturer-recommended installation position of the magnetic-inductive flowmeter 2 in the process, which is not shown. The display 16 in the housing 17 is positioned in an upper region in the housing 17. The fixed coordinate system x, y, z shown only in FIG. 5A for reasons of clarity must be thought of in the center of each measuring tube 3 in FIGS. 5A, 5B and 5C, i.e. where the dotted device coordinate system x′, y′, z′ is drawn in the center of the measuring tube 3 in the left-hand illustration of FIG. 5A. The device coordinate system is stationary in relation to the flowmeter 2 and also moves with the position of the flowmeter in a way that deviates from the standard installation 13. In the example, the x′ axis always points in the direction of the measuring tube axis regardless of the installation of the flowmeter 2, the y′ axis always points in the direction of the connecting line of the measuring electrodes 6a, 6b and the z′ axis always points in the direction of the display 16.

FIGS. 5B and 5C each show actual installations 14 of the magnetic-inductive flowmeter 2 that deviate from the standard installation. In FIG. 5B, the magnetic-inductive flowmeter 2 is swiveled around the x-axis by the swivel angle alpha_x=90° (left) or FIG. 5C shows the overhead installation of the magnetic-inductive flowmeter 2, i.e. with a swivel angle of alpha_x=180° around the x-axis. In this respect, FIG. 5 provides an overview of the standard installation 13 and deviating actual installations 14 of magnetic-inductive flowmeters 2.

In the methods 1 shown in FIG. 5, a test test3 is implemented on dry measuring electrodes 6a, 6b, in which the measuring electrode voltages Ue1, Ue2 are evaluated. The measured supply voltage Uin_mess and the captured measuring electrode voltages Ue1, Ue2 are indicated. The supply voltage also has a characteristic time characteristic here and causes corresponding measuring electrode voltages Ue1, Ue2 of a lower signal level, provided that the measuring electrodes 6a, 6b are not dry or none of the circuit electrodes 8a, 8b are dry. In FIGS. 5a (right), 5b and 5c, at least one of the electrodes 6a, 6b, 8a, 8b is dry in each case.

A measure implemented in the method 1 according to FIG. 5 in order to determine more precise information on the question of which electrode 6a, 6b, 8a, 8b is dry is that information on at least the highest electrode 6a, 6b, 8a, 8b of the measuring electrodes 6a, 6b and circuit electrodes 8a, 8b is initially stored in the magnetic-inductive flowmeter 2. Preferably, this electrode is then checked by a corresponding test on a dry measuring electrode 6a, 6b or a corresponding test on a dry circuit electrode 8a, 8b. For example, if the standard installation 13 of the magnetic-inductive flowmeter 2 shown in FIG. 5A is used, then the highest electrodes have the order 8a, 6a/6b, 8b. In this case, a specific test test3 on a dry measuring electrode 6a, 6b cannot be performed, as in any case the highest electrode 8a will be the first electrode to be dry, so that the level circuit 10 is interrupted and no signal can be detected via the measuring electrodes 6a, 6b (FIG. 5A, right). It makes sense here to perform a test exclusively on a dry circuit electrode 8a, 8b.

In the magnetic-inductive flowmeter 2 shown in FIG. 5B, left, the highest electrodes have the order 6b, 8a/8b, 6a. A positive test test3 on a dry measuring electrode 6a and a simultaneous negative test test3 on a dry measuring electrode 6b leads to a contradiction, since the measuring electrode 6b as the highest measuring electrode 6 can be dry without the measuring electrode 6a being dry, but not vice versa. The same applies to the installation situation in FIG. 5B, right. The installation positions shown in FIG. 5B allow both the test on dry measuring electrodes 6 and on (subsequently) dry circuit electrodes 8a, 8b.

For overhead installation as shown in FIG. 5C, the order of the highest electrodes 8b, 6a/6b, 8a. As for the standard installation 13 in FIG. 5A, the same applies here that a test test3 on a dry-lying measuring electrode 6a, 6b cannot be reasonably performed, which is why the fill level measuring mode is limited to the test of a dry circuit electrode 8a, 8b.

The examples are therefore based on checking whether the highest electrode 6a, 6b, 8a, 8b is the first electrode to be identified as a dry electrode. In the case of several electrodes 6a, 6b, 8a, 8b recognized as dry, it is checked whether the highest electrode 6, 8 has also been recognized as dry. If information about the installation height of several of the measuring electrodes 6a, 6b and current circuit electrodes 8a, 8b is stored, a check is carried out when several dry electrodes 6a, 6b, 8a, 8b are detected to determine whether these are the several highest electrodes 6a, 6b, 8a, 8b.

The method 1 and the illustrated magnetic-inductive flowmeters 2 in FIG. 5 are further characterized in that the magnetic-inductive flowmeter 1 automatically determines the highest electrode 6a, 6b, 8a, 8b or the multiple highest electrodes 6a, 6b, 8a, 8b on the basis of the installation positions of the measuring electrodes 6a, 6b and the circuit electrodes 8a, 8b in the magnetic-inductive flowmeter 2 in a standard installation 13 and on the basis of at least one piece of deviation information about an actual installation 14 deviating from the standard installation 13, in which the magnetic-inductive flowmeter 2 is actually installed. The deviation information comprises at least one swivel angle alpha_x, alpha_y, alpha_z with respect to an axis of rotation x, y, z of a device coordinate system in standard installation 13. In the examples, this is the swivel angle alpha_x with respect to the axis of rotation x in the axial direction of the measuring tube 3. So that the flowmeter can independently determine the actual installation 14 and the deviation information in relation to the standard installation 13, an acceleration sensor 18 is installed in the magnetic-inductive flowmeter 2, with which the swivel angles can be easily determined. With known swivel angles alpha_x, alpha_y, alpha_z, the height information of the electrodes 6, 8 in actual installation 14 can be easily determined by applying rotation matrices from the installation positions of the electrodes 6, 8 in standard installation 13.

For all examples shown (except FIG. 1), the control and evaluation unit 7 can be designed in such a way that it performs the method 1 shown in the figures in fill level measurement mode.

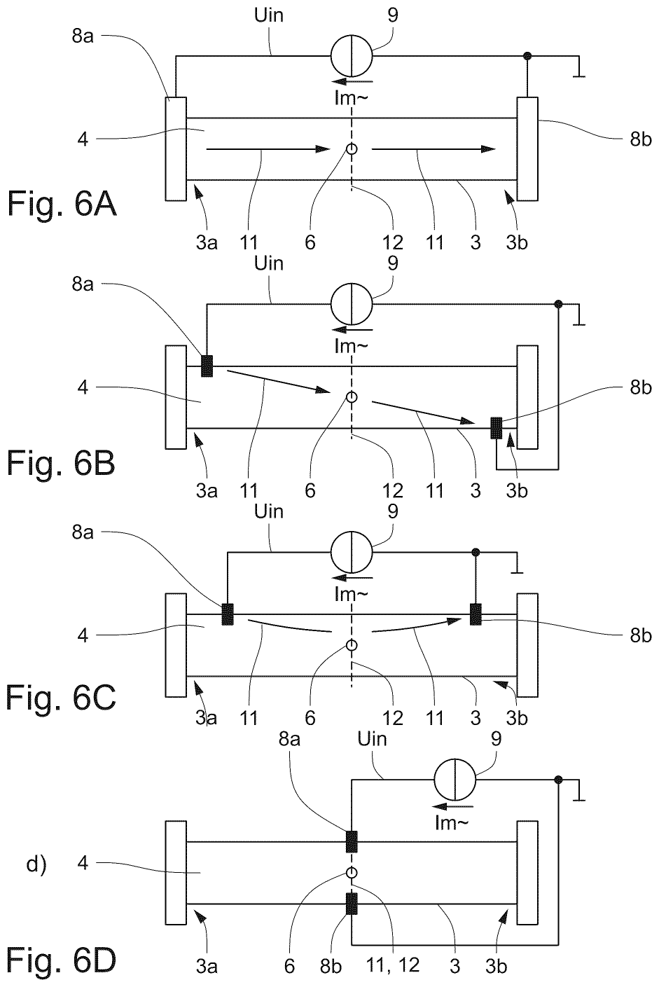

FIGS. 6A to 6D show different variations of the implementation of the circuit electrodes 8a, 8b in the area of the measuring tube 3. In principle, the circuit electrodes 8a, 8b must be inserted into the measuring tube 3 or designed in the measuring tube 3 in such a way that they are not short-circuited by the measuring tube 3, because the conductivity circuit 10 must be closed via the medium 4, there via the medium current path 11 in the medium 4, in order for the fill level measurement to work.

FIG. 2 already shows a magnetic-inductive flowmeter 2 in which one of the circuit electrodes 8b is designed as a conductive flange at the end of the measuring tube 3. In the magnetic-inductive flowmeter 2 according to FIG. 6A, both circuit electrodes 8a, 8b are designed as a conductive flange at the end of the measuring tube 3, the first circuit electrode 8a is arranged as one flange in the inflow region 3a and the second circuit electrode 8b is arranged as the other flange in the outflow region 3b of the measuring tube 3. Here, the flanges are electrically insulated on the outside, but not on the inside, so that electrical contact with the medium 4 is ensured.

In the magnetic-inductive flowmeters 2 according to FIGS. 2A, 6B and 6C, at least one of the circuit electrodes 8a in the area of the measuring tube 3 is arranged axially offset to a measuring electrode plane 12 in which the measuring electrodes 6a, 6b are arranged and which measuring electrode plane 12 runs perpendicular to the axial extension of the measuring tube 4, the measuring electrodes 6a, 6b are also located between the inflow region 3a and the outflow region 3b. In the examples shown in FIGS. 6b and 6c, this even applies to both of the circuit electrodes 8a, 8b. The positioning of the circuit electrodes 8a, 8b shown in these examples is associated with additional design effort, as the circuit electrodes 8a, 8b must be electrically insulated in the wall of the measuring tube 3 and must also meet the mechanical strength requirements and the fluid sealing requirements. However, this also offers the possibility of accommodating the circuit electrodes 8a, 8b in a particularly protected manner, both against contact from the outside (as the measuring tube 3 is usually surrounded by the housing 17) and against contact from inside the measuring tube 3, for example by abrasive media, as the circuit electrodes 8a, 8b can be mounted flush with the measuring tube wall or even recessed.

In the magnetic-inductive flowmeter 2 shown in FIG. 6D, the circuit electrodes 8a, 8b are arranged in the measuring electrode plane 12. The connecting line between the circuit electrodes 8a, 8b is perpendicular to the connecting line between the measuring electrodes 6a, 6b, so that the medium flow path 11, via which the supply voltage Uin drops, passes directly by the measuring electrodes 6a, 6b. Since the measuring electrodes 6a, 6b are arranged centrally between the inflow region 3a and the outflow region 3b of the measuring tube 3, the current circuit electrodes 8a, 8b are also centrally located between the inflow region 3a and the outflow region 3b of the measuring tube 3.

The measuring electrodes 6a, 6b and the circuit electrodes 8a, 8b lie on a circumferential line of the measuring tube 3, which has certain manufacturing advantages. Interestingly, however, with the designs in which the current circuit electrodes 8a, 8b are arranged axially, i.e. offset in the direction of flow of the medium 4 relative to the measuring electrodes 6a, 6b and thus also the measuring electrode plane 12, so that the medium flow path 11 also has an axial extension component in the measuring tube 3, better results can be achieved with regard to determining the electrical variables of interest of the medium 4, in particular the measuring electrode voltages Ue1, Ue2, which applies throughout to the other examples, i.e. to the magnetic-inductive flowmeters 2 according to FIGS. 2, 5 and 6A to 6C.

To ensure that an incompletely filled measuring tube 3 can be detected as early as possible, all magnetic-inductive flowmeters 2 shown in the figures are characterized in that one of the circuit electrodes 8, namely the first circuit electrode 8a, is arranged at an upper apex of a measuring tube cross-section transverse to the measuring tube axis; in fact, the highest apex of the measuring tube cross-section has always been selected; this always refers to the upper apex with standard installation 13 of the magnetic-inductive flowmeter 2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a magnetic-inductive flowmeter that comprises at least one measuring tube with an inflow region, an outflow region, and a measuring region located between the inflow region and the outflow region for conducting a flowing medium through the flowmeter, the method comprising:
generating, via at least one magnetic field generator, a magnetic field passing through the measuring tube in the measuring region substantially perpendicular to a direction of flow of the medium;
providing at least one pair of measuring electrodes in the measuring region of the measuring tube to tap an electrical voltage induced in the medium in the measuring tube;
determining in a flow measurement mode, via at least one control and evaluation unit, a flow measurement value from the measured induced electrical voltage;
arranging a first current circuit electrode and a second current circuit electrode in a region of the measuring tube in contact with the medium, at least when the measuring tube is filled with medium to a predetermined fill level;
connecting the current circuit electrodes to a current source outside the measuring tube;
specifying, in a fill level measuring mode of the current source, a target measuring current, to which the current circuit electrodes are subjected, the current circuit electrodes being arranged such that a fill level current circuit closes via a medium flow path in the medium at least when the measuring tube is filled with the medium to the predetermined fill level, the medium current path passing through the flow cross-section of the measuring tube in which the measuring electrodes are located, so that an electrical voltage drop results between the circuit electrodes in the medium;
detecting, via a dry circuit electrode and/or a dry measuring electrode in a fill level measuring mode, by measurement-based capture; and
evaluating at least one of the following variables: at least one of the captured measuring electrode voltages, the measuring current emitted by the current source, a supply voltage caused by the current source at the first circuit electrode, and/or that a status “dry electrode” is at least indirectly signaled when a dry circuit electrode and/or a dry measuring electrode is detected.

2. The method according to claim 1, wherein, when the status “dry electrode” is detected, it is additionally signaled which of the current circuit electrodes and/or the measuring electrodes is dry, or wherein a fill level indication of the medium in the measuring tube is additionally indicated.

3. The method according to claim 1, wherein the first current circuit electrode is connected by the current source to a supply potential and the second current circuit electrode is connected to a reference potential, or wherein the reference potential is the electrical reference potential to which the measuring electrode voltages are also measured.

4. The method according to claim 1, wherein the current source generates an alternating current with a constant amplitude or a direct current with a constant level as the measuring current.

5. The method according to claim 1, wherein, in the fill level measuring mode for testing a dry circuit electrode, the measuring current emitted by the current source is captured measurement-based and, if the measured measuring current falls below the target measuring current predetermined for the current source, or when the deviation is greater than a permissible maximum deviation, or the measured measuring current is less than a predetermined minimum measuring current, or the measured measuring current is zero, at least one dry circuit electrode is detected.

6. The method according to claim 1, wherein the voltage difference between the measurement-based captured supply voltage at the first circuit electrode and a current source output voltage set by the current source is determined in the fill level measuring mode for testing a dry circuit electrode, and wherein the dry circuit electrode is identified when the absolute value of the determined voltage difference is less than a predetermined minimum voltage difference.

7. The method according to claim 1, wherein, in the fill level measuring mode for testing a dry measuring electrode, a voltage ratio of the captured measuring electrode voltage of the respective measuring electrode to the measurement-based supply voltage at the first circuit electrode is determined and a dry measuring electrode is identified when the determined voltage ratio of the relevant measuring electrode falls below a predetermined voltage ratio value, and wherein a dry measuring electrode is only inferred when at least one of the tests for a dry circuit electrode is also negative.

8. The method according to claim 1, wherein the current source is specified a target measurement current with a characteristic time characteristic or in the form of a rectangular sequence or a sawtooth curve, wherein upon evaluation of one of the measurement-based variables or one of the captured measurement electrode voltages of the measurement current emitted by the current source, the supply voltage caused by the current source at the first current circuit electrode, it is checked whether the measurement-based variable has a corresponding characteristic time characteristic, and wherein, if the measurement-based variable has a corresponding characteristic time characteristic, the measurement-based variable is classified as reliably present, otherwise it is classified as not reliably present.

9. The method according to claim 1, wherein the flow measuring mode is suspended during the fill level measuring mode, or wherein the magnetic field generating device is not energized so that no magnetic field is generated.

10. The method according to claim 1, wherein information about at least the highest electrode of the measuring electrodes and current circuit electrodes is stored and this electrode is checked by a corresponding test for a dry measuring electrode or a corresponding test for a dry circuit electrode.

11. The method according to claim 1, wherein information about at least the highest electrode of the measuring electrodes and current circuit electrodes is stored in the magnetic-inductive flowmeter, wherein the information about the highest electrode is used to subject the result of a test carried out on a dry measuring electrode and/or a dry circuit electrode to a plausibility test, or wherein it is checked whether the highest electrode has been identified as the first electrode as a dry electrode, or wherein it is checked whether, in the case of a plurality of electrodes identified as dry, the highest electrode has also been identified as dry.

12. The method according to claim 1, wherein information about the installation height of a plurality of the measuring electrodes and current circuit electrodes is stored in the magnetic-inductive flowmeter and, if a plurality of dry electrodes are detected, it is checked whether these are the plurality of highest electrodes.

13. The method according to claim 10, wherein the magnetic-inductive flowmeter automatically identifies its highest electrode or the plurality of highest electrodes on the basis of the installation positions of the measuring electrodes and the circuit electrodes in the magnetic-inductive flowmeter in a standard installation and on the basis of at least one piece of deviation information about an actual installation deviating from the standard installation, in which the magnetic-inductive flowmeter is actually installed, or wherein the deviation information comprises at least one swivel angle with respect to an axis of rotation or at least one swivel angle with respect to an axis of rotation in the axial direction of the measuring tube, or wherein the swivel angle is input or is determined by an acceleration sensor of the magnetic-inductive flowmeter.

14. A magnetic-inductive flowmeter comprising:
at least one measuring tube with an inflow region, an outflow region, and a measuring region arranged between the inflow region and the outflow region for conducting a flowing medium through the flowmeter;
at least one magnetic field generating device for generating a magnetic field passing through the measuring tube in the measuring region substantially perpendicular to the direction of flow of the medium;
at least one pair of measuring electrodes arranged in the measuring region of the measuring tube for tapping an electrical voltage induced in the medium in the measuring tube;
at least one control and evaluation unit that determines a flow measurement value from the measured induced electrical voltage in a flow measurement mode; and
a first circuit electrode and a second circuit electrode arranged in a region of the measuring tube in contact with the medium, at least when the measuring tube is completely filled with medium, the circuit electrodes are connected outside the measuring tube to a current source and, in a fill level measuring mode of the current source, a target measuring current is specified to which the circuit electrodes are subjected, wherein the current circuit electrodes are arranged such that a fill level circuit closes via a medium flow path in the medium, at least when the measuring tube is completely filled with medium,
wherein the medium current path passes the flow cross-section of the measuring tube in which the measuring electrodes are located, so that an electrical voltage drop results between the circuit electrodes in the medium, and
wherein the control and evaluation unit performs the method according to claim 1 in the level measurement mode.

15. The magnetic-inductive flowmeter according to claim 14, wherein at least one of the circuit electrodes is a conductive flange at an end of the measuring tube.

16. The magnetic-inductive flowmeter according to claim 15, wherein one of the circuit electrodes is designed as a conductive flange in the inflow region and as a conductive flange in the outflow region of the measuring tube.

17. The magnetic-inductive flowmeter according to claim 14, wherein one of the circuit electrodes is arranged at an upper apex of a measuring tube cross-section transverse to the measuring tube axis, or is arranged at the highest apex of the measuring tube cross-section, and wherein the upper apex is present during standard assembly of the magnetic-inductive flowmeter.

18. The magnetic-inductive flowmeter according to claim 14, wherein at least one of the circuit electrodes is arranged in the region of the measuring tube axially offset with respect to a measuring electrode plane in which the measuring electrodes are arranged and which runs substantially perpendicular to the axial extent of the measuring tube or between the inflow region and the outflow region, or wherein the first and second current circuit electrodes are arranged in the region of the measuring tube axially offset to the measuring electrode plane and between the inflow region and the outflow region.

19. The magnetic-inductive flowmeter according to claim 14, wherein one of the circuit electrodes is arranged in the measuring electrode plane, or wherein both circuit electrodes are arranged in the measuring electrode plane).
